(19) United States
(12) Patent Application Publication
(10) Pub. No.: US 2017/0011221 A1
(43) Pub. Date: Jan. 12, 2017

(54) PREVENTION OF CARTRIDGE REUSE THROUGH ENCRYPTION

(71) Applicant: THE COCA-COLA COMPANY, Atlanta, GA (US)

(72) Inventors: C. Brad Green, Dacula, GA (US); David R. Newman, Atlanta, GA (US)

(73) Assignee: THE COCA-COLA COMPANY, Atlanta, GA (US)

(21) Appl. No.: 15/121,884

(22) PCT Filed: Feb. 25, 2015
(86) PCT No.: PCT/US2015/017534

§ 371 Date: Aug. 26, 2016

Related U.S. Application Data
(60) Provisional application No. 61/946,116, filed on Feb. 28, 2014.

(51) Int. Cl. G06F 21/60; G06K 7/10

(52) U.S. Cl. CPC G06F 21/602; G06K 7/10366

(57) ABSTRACT

Preventing the reuse of cartridges in a dispenser using encryption is provided. A cartridge for dispensing a product may be received by a dispenser. The dispenser may then read an encrypted tag from the cartridge and decrypt the encrypted tag. The dispenser may then retrieve a current usage status for the cartridge based on the decrypted tag and determine, from the current usage status, whether the cartridge has been retired. The dispenser may then generate an alert message upon determining that the cartridge has been retired.

### CROSS REFERENCE TO RELATED APPLICATIONS

This application is a U.S. National stage application of PCT/US15/017534, which was filed on Feb. 25, 2015, as a PCT International Patent application and claims priority to U.S. Provisional patent application No. 61/946,116, filed Feb. 28, 2014, the entire disclosures of which are incorporated by reference in their entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Many home and store-based dispensing devices utilize replaceable cartridges containing ingredients (e.g., syrups and flavors) for dispensing various products (e.g., beverages) for consumers. In order to maintain product consistency and quality, the distribution of the cartridges may be restricted to approved distributers. Accordingly, when cartridges become depleted, replacement cartridges may only be obtained from the approved distributers. Dispenser manufacturers or operators however, while maintaining the ability to control tampering with their dispensers (e.g., via network software updates), often lack the ability to control cartridge reuse by users or consumers desiring to refill depleted or partially depleted cartridges with alternative ingredients. As a result, dispensers may be at risk of dispensing products which may result in reduced product quality and consistency. Moreover, there may be a risk of increased maintenance costs due to damage which may result from passing products containing alternative ingredients through the dispensers. It is with respect to these considerations and others that the various embodiments of the present invention have been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are provided for preventing the reuse of cartridges in a dispenser using encryption. A cartridge for dispensing a product may be received by a dispenser. The dispenser may then read an encrypted tag from the cartridge and decrypt the encrypted tag. The dispenser may then retrieve a current usage status for the cartridge based on the decrypted tag and determine, from the current usage status, whether the cartridge has been retired. The dispenser may then generate an alert message upon determining that the cartridge has been retired.

These and other features and advantages will be apparent from a reading of the following detailed description and a review of the associated drawings. It is to be understood that both the foregoing general description and the following detailed description are illustrative only and are not restrictive of the invention as claimed.

### BRIEF DESCRIPTION OF THE DRAWINGS

FIG. 1 is a block diagram illustrating a network architecture for preventing the reuse of cartridges in a dispenser using encryption, in accordance with an embodiment;

FIG. 2 is a block diagram illustrating a network architecture for tracking the use of cartridges between dispensers to prevent their reuse, in accordance with an embodiment;

FIG. 3 is a block diagram illustrating a cartridge with an encrypted tag which may be utilized in the dispensers of FIGS. 1 and 2, in accordance with an embodiment;

FIG. 4 is a block diagram illustrating a data structure for an encrypted tag, in accordance with an embodiment;

FIG. 5 is a flow diagram illustrating a routine for preventing the reuse of cartridges in a dispenser using encryption, in accordance with an embodiment;

FIG. 6 is a flow diagram illustrating a routine for tracking the use of cartridges between dispensers to prevent their reuse, in accordance with an embodiment;

FIG. 7 is a block diagram illustrating a user interface display for tracking cartridge volume and reordering additional cartridges, in accordance with an embodiment; and

FIG. 8 is a simplified block diagram of a dispenser with which various embodiments may be practiced.

### DETAILED DESCRIPTION

Embodiments are provided for preventing the reuse of cartridges in a dispenser using encryption. A cartridge for dispensing a product may be received by a dispenser. The dispenser may then read an encrypted tag from the cartridge and decrypt the encrypted tag. The dispenser may then retrieve a current usage status for the cartridge based on the decrypted tag and determine, from the current usage status, whether the cartridge has been retired. The dispenser may then generate an alert message upon determining that the cartridge has been retired.

In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents.

It should be understood that “beverage,” as used herein, includes, but is not limited to, pulp and pulp-free citrus and non-citrus fruit juices, fruit drink, vegetable juice, vegetable drink, milk, soy milk, protein drink, soy-enhanced drink, tea, water, isotonic drink, vitamin-enhanced water, soft drink, flavored water, energy drink, coffee, smoothies, yogurt drinks, hot chocolate and combinations thereof. The beverage may also be carbonated or non-carbonated. The beverage may comprise beverage components (e.g., beverage bases, colorants, flavorants, and additives).

The term “beverage base” refers to parts of the beverage or the beverage itself prior to additional colorants, additional flavorants, and/or additional additives. According to certain embodiments of the present invention, beverage bases may include, but are not limited to syrups, concentrates, and the like that may be mixed with a diluent such as still or carbonated water or other diluent to form a beverage. The beverage bases may have reconstitution ratios of about 3:1 to about 6:1 or higher. According to certain embodiments, beverage bases may comprise a mixture of beverage base components.

The term “beverage base component” refers to components which may be included in beverage bases. According to certain embodiments of the present invention, the beverage base component may comprise parts of beverages which may be considered food items by themselves. According to certain embodiments of the present invention, the beverage base components may be micro-ingredients such as an acid portion of a beverage base, an acid-degradable and/or non-acid portion of a beverage base, natural and artificial flavors, flavor additives, natural and artificial colors, nutritive or non-nutritive natural or artificial sweeteners, additives for controlling tartness (e.g., citric acid or potassium citrate), functional additives such as vitamins, minerals, or herbal extracts, nutraceuticals, or medicaments. The micro-ingredients may have reconstitution ratios from about 10:1, 20:1, 30:1, or higher with many having reconstitution ratios of 50:1 to 300:1. The viscosities of the micro-ingredients may range from about 1 to about 100 centipoise.

Thus, for the purposes of requesting, selecting, or dispensing a beverage base, a beverage base formed from separately stored beverage base components may be equivalent to a separately stored beverage base. For the purposes of requesting, selecting or dispensing a beverage, a beverage formed from separately stored beverage components may be equivalent to a separately stored beverage.

By “separately stored” it is meant that the components of the present invention are kept separate until combined. For instance, the components may be separately stored individually in each container/cartridge or may be all stored in one container/cartridge wherein each component is individually packaged (e.g., plastic bags) so that they do not blend while in the container/cartridge. In some embodiments, the container, itself, may be individual, adjacent to, or attached to another container/cartridge.

The term “blended beverage” includes final products wherein two or more beverages have been blended or mixed or otherwise combined to form a final product.

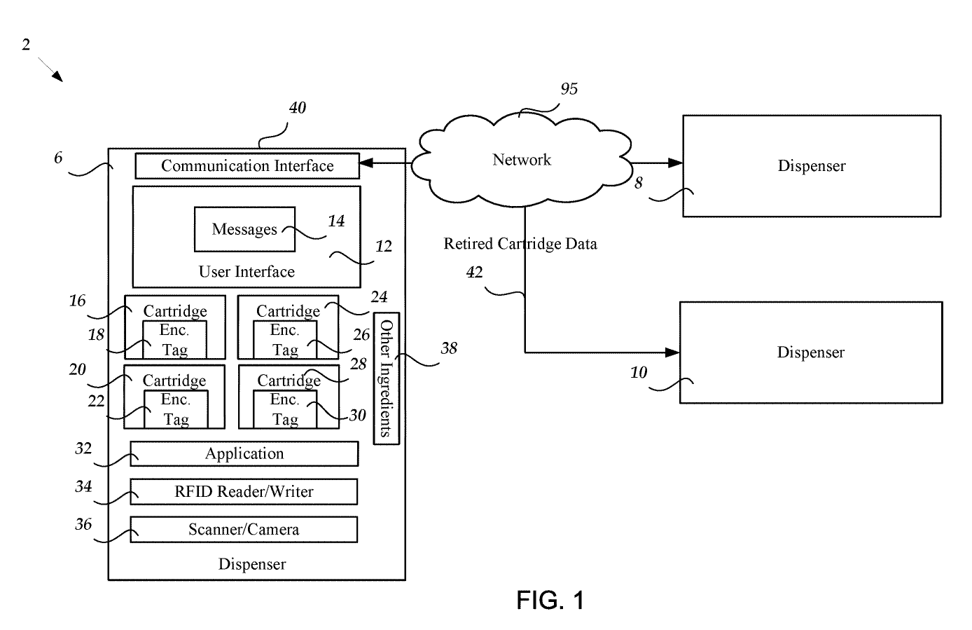

Referring now to the drawings, in which like numerals represent like elements through the several figures, various aspects of the present invention will be described. FIG. 1 is a block diagram illustrating a network architecture 2 for preventing the reuse of cartridges in a dispenser using encryption, in accordance with an embodiment. The network architecture 2 includes a dispenser 6 which may be in communication with dispensers 8 and 10 over a network 95 which may include a local network or a wide area network (e.g., the Internet). In some embodiments, the communication between the dispenser 6 and the dispensers 8 and 10 may be accomplished utilizing any number of communication techniques known to those skilled in the art including, but not limited to, BLUETOOTH wireless technology, Wi-Fi and other wireless or wireline communication standards or technologies, via communication interface 40. The dispensing device 6 may be comprise various products which may include beverage bases or beverage base components (e.g., concentrated syrups or micro-ingredients) as well as flavors (i.e., flavoring agents, flavor concentrates, or flavor syrups), which may be separately stored or otherwise contained in individual removable cartridges 16, 20, 24 and 28 in the dispenser 6. In some embodiments, the dispenser 6 (as well as the dispensers 8 and 10) may be capable of metering sweetener containing syrups with reconstitution between 5:1 and 8.5:1 (with a volumetric delivery accuracy of +/−5%), capable of automatically adjusting syrup delivery rate in a range of mix ratios of between 5:1 and 8.5:1 (based on the identification of an inserted product (e.g., cartridge) and stored recipe data) and capable of delivering concentrated beverage base components or flavor modifiers with reconstitution ratios between 150:1 and 300:1 (with a volumetric accuracy of +/−5%).

The dispenser 6 may automatically identify the cartridges 16, 20, 24 and 28 upon installation by a user or the user may be prompted to identify the cartridges 16, 20, 24 and 28 when they are installed. It should be appreciated that the aforementioned beverage components (i.e., beverage bases or beverage base components and flavors) may be combined, along with other beverage ingredients 38, to dispense various products which may include beverages or blended beverages (i.e., finished beverage products) from the dispenser 6. It should be understood however, that the dispenser 6 may also be configured to dispense beverage components individually. In some embodiments, the dispenser 6 may be configured to dispense beverage base components so as to form a beverage base. The other beverage ingredients 38 may include diluents such as still or carbonated water, functional additives, or medicaments, for example. The other beverage ingredients 38 may be installed in the dispenser 6, pumped to the dispenser 6, or both. The carbonated water may be produced in the dispenser device 6 through mixing of CO₂ and still water such as in a carbonator or other device that produces carbonated water.

Each of the cartridges 16, 20, 24 and 28 may include encrypted tags 18, 22, 26 and 30, respectively. As will be discussed in greater detail below, each of the encrypted tags 18, 22, 26 and 30 may comprise a radio frequency identification (“RFID”) label, a barcode, and/or a character string which may be affixed to or printed on the cartridges 16, 20, 24 and 28. The RFID labels may be read on the dispenser 6 via RFID Reader/Writer 34 while the barcodes (which may comprise a one or two-dimensional barcodes such as QR codes) may be scanned into the dispenser 6 via scanner/camera 36. In one embodiment, the RFID label may be automatically read by the RFID Reader/Writer 34 upon insertion of a cartridge into the dispenser 6 and the barcode may be scanned by a user (e.g., from a cartridge label) using the scanner/camera 36, prior to insertion of the cartridge into the dispenser. For example, the scanner/camera 36 may be utilized to take a picture of the barcode and utilize image analysis software to “read” the barcode from the cartridge label. As another example, the scanner/camera 36 may comprise an optical sensor which is paired with an optical character recognition software application for reading encrypted character strings. Alternatively, for dispensers that may not have a system (e.g., an optical sensor) for directly reading character strings, a user may manually input the character string into the dispenser 6 via the user interface 12. For example, prior to inserting the cartridge 16, the user may manually enter a character string via the user interface 12. It should be understood that in some embodiments, the character string may appear to the user as of random alphanumeric characters. However, the dispenser 6 may be configured to decrypt the character string to identify the cartridge as a consumable product (e.g., a beverage product) or a consumable product ingredient (e.g., a beverage ingredient). In other embodiments, the character string may also be embedded in an RFID tag or barcode. It should be understood that the encrypted tags 18, 22, 26 and 30 may take any machine readable form sufficient to convey the data structure 21 or a subset thereof, as described in greater detail below. Correspondingly, the dispenser 6 may include any appropriate reader to read the encrypted tags 18, 22, 26 and 30.

In one embodiment, the tags 18, 22, 26 and 30 may be encrypted utilizing Advanced Encryption Standard (“AES”) encryption (e.g., AES 32). It should be understood however, that other key scrambling techniques known to those skilled in the art may also be employed. In some embodiments, the encryption key may be either a public or private key. For example, the encryption key may be a private key known only to a manufacturer or distributer of dispensers and dispenser cartridges. It should further be understood that the encryption keys may either be static or updatable. The keys may be updated by the dispenser via regular firmware updates or periodic key updates over a network or via a universal serial bus (“USB”) connection on the dispenser itself.

The dispenser 6 may further comprise an application 32 which may be configured to decrypt the encrypted tags 18, 22, 26 and 30 (i.e., after they have been read by the RFID Reader/Writer 34 or the scanner/camera 36) in order to retrieve cartridge data which may include, without limitation, a cartridge identification (e.g., a numerical or alphanumerical designation), a product brand or ingredient dispensed by the cartridge, a product volume remaining in the cartridge, a use-by date for dispensing a product or ingredient contained in the cartridge and a “sold out status” for a product which has been previously dispensed from the cartridge. In one embodiment, the application 32 may be configured to track the dispensing of a product from the dispenser 6 and to further update a product volume field in the cartridge data by utilizing the RFID Reader/Writer 34 to write back to the cartridge's RFID label with an updated product volume (e.g., 50% full) or otherwise store and track the remaining product volume in a local or remote database. In some embodiments, a user/operator of the dispenser 6 may update a local or remote database each time a cartridge is sold out or the dispenser 6 may be configured to automatically track and update a sold out status indicator based on cartridge use over time.

In some embodiments, the application 32 may be configured to determine, from the retrieved cartridge data, whether a cartridge has been retired and/or previously depleted, and generate one or more messages 14 in a user interface 12 on the dispenser 6. In some embodiments, a user may interact with the user interface 12 via touch input to access one or more menus from which to select and dispense a product, replace or remove a cartridge, check the status of installed cartridges (including remaining product volume and product use-by date data), order supplies (i.e., order new cartridges to replace depleted cartridges), etc. In other embodiments, the user interface 12 may enable a user to type in a code using an onscreen or physical keyboard (not shown) on the dispensing device 6 to access the aforementioned menus, for.

In some embodiments, the messages 14 may include a Retired Cartridge Data message 42 (i.e., indicating that a cartridge has been retired and thus should not be reused in a dispenser). The application 32 may further be configured to communicate the Retired Cartridge Data message 42 to other dispensers 8 and 10 via the network 95. It should be understood that the dispensers 8 and 10 may comprise the same or similar components as those described above with respect to the dispenser 6. It should be appreciated that the communication of the Retired Cartridge Data message 42 to other dispensers may prevent the reuse of cartridges among multiple dispensers in a dispenser network.

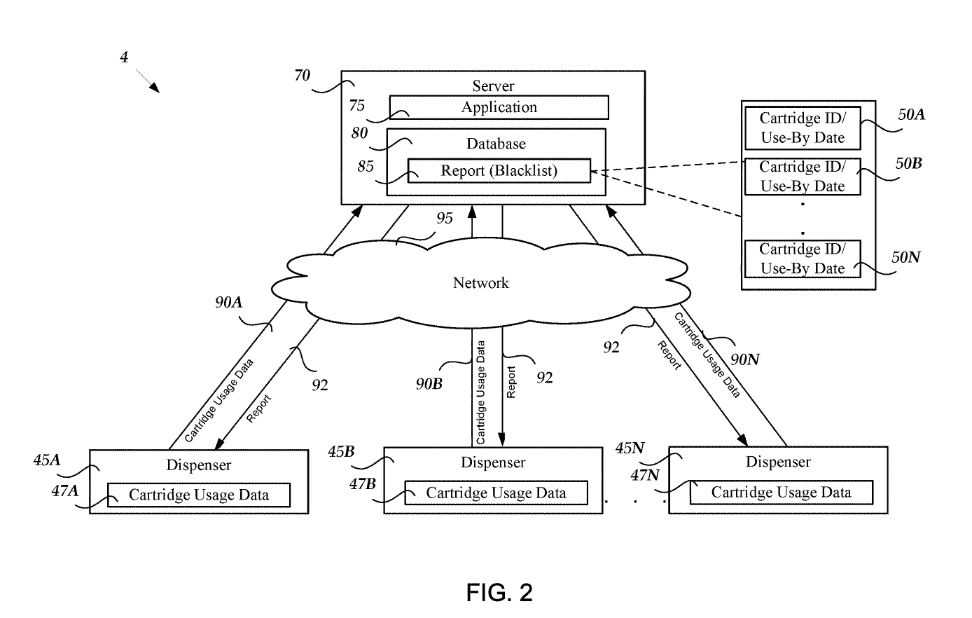

FIG. 2 is a block diagram illustrating a network architecture 4 for tracking the use of cartridges between dispensers to prevent their reuse, in accordance with an embodiment. The network architecture 4 includes dispensers 45A, 45B and 45N, each of which may be in communication with server 70 over the network 95. In some embodiments, the communication between the dispensers 45A-45N and the server 70 may be accomplished utilizing any number of communication techniques known to those skilled in the art including Wi-Fi and other wireless or wireline communication standards or technologies. A discussed above with respect to the dispenser 6 of FIG. 1, each of the dispensers 45A-45N may comprise various products which may include beverage bases or beverage base components (e.g., concentrated syrups or micro-ingredients) as well as flavors (i.e., flavoring agents, flavor concentrates, or flavor syrups), which may be separately stored or otherwise contained in individual removable cartridges (not shown). The dispensers 45-45N may be configured to communicate cartridge usage data 47A, 47B and 47N for their respective cartridges to the server 70 via messages 90A, 90B and 90N over the network 95. The cartridge usage data 47A-47N may include a cartridge identification (e.g., a numerical or alphanumerical designation), a product brand or ingredient dispensed by the cartridge, a product volume remaining in the cartridge, a use-by date for dispensing a product or ingredient contained in the cartridge and a “sold out status” for a product which has been previously dispensed from the cartridge. As discussed above with respect to FIG. 1, the cartridge usage data 47A-47N may be incorporated in encrypted tags on each of the dispenser cartridges.

The server 70 may comprise an application 75 and a database 80. The application 75 may be configured to receive the cartridge usage data 47A-47N and save it to the database 80. The application 75 may further be configured, based on the information contained in the cartridge usage data 47A-47N, to generate a report 85 (e.g., a blacklist) listing the IDs paired with the use-by dates of retired and/or previously depleted cartridges (e.g., cartridge ID/use-by dates 50A, 50B and 50N) in the dispensers 47A-47N to prevent their reuse. For example, if the cartridge usage data 47A (received from the dispenser 45A) indicates that a product in a dispenser cartridge is past it's recommended use-by date, then the cartridge may be designated as retired and the cartridge ID and/or use-by date will be included in the report 85 generated by the application 75. The application 75 may also be configured to send the report 85 to each of the dispensers 45A-45N via a report message 92. Upon receiving the report message 92, the dispensers 45A-45N are notified of retired cartridges in a dispenser network thereby enabling individual dispensers (or users operating the dispensers) to prevent cartridge reuse. In one embodiment, the dispensers 45A-45N may be configured to communicate with the server 70 whenever a cartridge is inserted and query the server 70 for the report 85. In another embodiment, the server 70 may be configured to automatically send the report 85 to the dispensers 45A-45N on a periodic or scheduled basis (e.g., every morning at 2 A.M.) such that the dispensers 45A-45N may check currently installed cartridges against the report 85 to identify any retired cartridges. The dispensers 45A-45N may then prevent the dispensing of ingredients from any retired cartridges identified in the report 85.

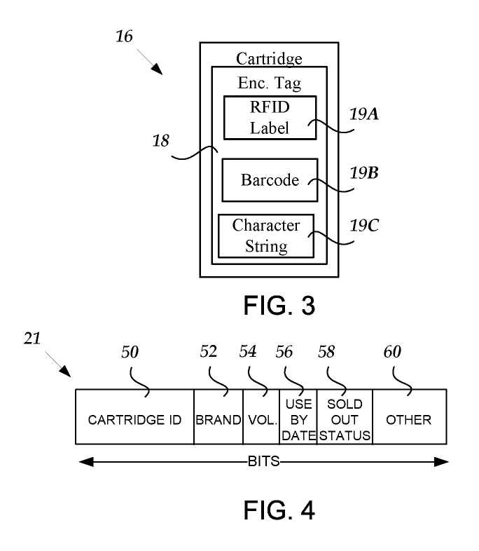

FIG. 3 is a block diagram illustrating a cartridge with an encrypted tag which may be utilized in the dispensers of FIGS. 1 and 2, in accordance with an embodiment. As discussed above with respect to FIG. 1, the cartridge 16 may comprise an encrypted tag 18 which may further include an RFID label 19A and/or barcode 19B and/or character string 19C. In some embodiments, the cartridge 16 may include the RFID label 19A, the barcode 19B and the character string 19C. For example, some dispensers may not have the ability to read RFID labels but may be equipped to read barcodes, or vice versa. As another example, other dispensers may not have a reader at all but may be equipped to receive a character string via manual data entry.

FIG. 4 is a block diagram illustrating a data structure 21 for an encrypted tag, in accordance with an embodiment. The data structure 21 may include fields 50, 52, 54, 56, 58 and 60 for storing various types of information about a dispenser cartridge. For example, the field 50 may be utilized to store a cartridge ID and/or use-by date which, in some embodiments, may comprise a unique identification for recognizing a cartridge in one more dispensers. The field 52 may be utilized to store a brand name associated with a product (e.g., a beverage) dispensed from the cartridge by the dispenser. The field 54 may be utilized to store a current volume of a product dispensed from the cartridge or a current volume of a product remaining in the cartridge. For static tags (e.g., tags that the field 54 may indicate a total volume of the product in the cartridge as modified), the field 56 may be utilized to store a use-by date for a product dispensed from the cartridge. The field 58 may be utilized to store a sold out status indicator for a product dispensed from the cartridge. For static tags, the field 58 may be omitted. The field 58 may be toggled upon all of the volume of the product in the cartridge being dispensed, or some percentage thereof (e.g., 110% of the total volume). The field 58 may also be toggled by the dispenser 6 upon one or more sensors (not shown) in the dispenser 6 detecting a sold out status (e.g., the dispenser 6 is pumping air). The field 60 may be utilized to store other data associated with the cartridge. In accordance with an embodiment, each of the fields 50-60 may comprise a predetermined number of bits allocated in the data structure 21 for storing data therein. For example, in one embodiment, the field 50 for storing the cartridge ID and/or use-by date may comprise 29 bits the field 58 for storing the sold out status indicator may comprise 2 bits. In some embodiments the data structure 21 may be comprise a range which is between 96 bits and 256 bits of data. Other ranges may also be utilized. In some embodiments, all of the bits in the data structure 21 may be encrypted while in other embodiments, only certain bits (such as the bits in the field 54 for storing the current product volume) may be encrypted.

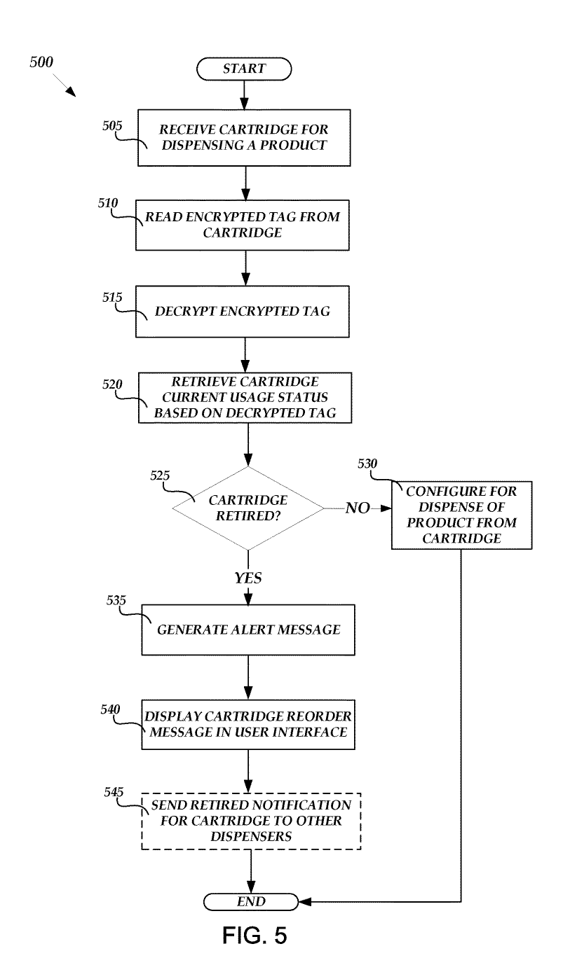

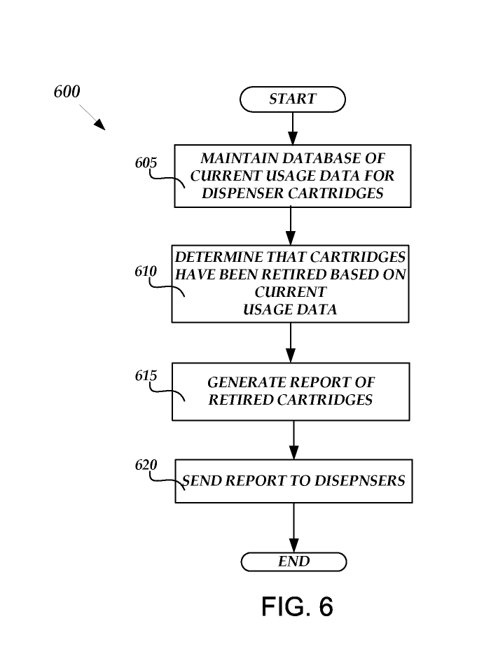

FIG. 5 is a flow diagram illustrating a routine 500 preventing the reuse of cartridges in a dispenser using encryption, in accordance with an embodiment. When reading the discussion of the routines presented herein, it should be appreciated that the logical operations of various embodiments of the present invention are implemented (1) as a sequence of computer implemented acts or program modules running on a computing device or system and/or (2) as interconnected machine logical circuits or circuit modules within the computing device or system. The implementation is a matter of choice dependent on the performance requirements of the computing device or system implementing the invention. Accordingly, the logical operations illustrated in FIGS. 5-6 and making up the various embodiments described herein are referred to variously as operations, structural devices, acts or modules. It will be recognized by one skilled in the art that these operations, structural devices, acts and modules may be implemented in software, in firmware, in hardware, in special purpose digital logical, and any combination thereof without deviating from the spirit and scope of the present invention as recited within the claims set forth herein.

The routine 500 begins at operation 505, where a dispenser (e.g., the dispenser 6 of FIG. 1) may receive a cartridge for dispensing a product. For example, a user of the dispenser 6 may insert a cartridge 16 bearing encrypted tag 18 in preparation of dispensing a beverage or beverage component therefrom.

From operation 505, the routine 500 continues to operation 510, where the application 32 executing on the dispenser 6, may read the encrypted tag from the received cartridge. In various embodiments, the encrypted tag may comprise an RFID label, a barcode or both or some other machine readable tag, token or symbol.

From operation 510, the routine 500 continues to operation 515, where the application 32 executing on the dispenser 6, may decrypt the encrypted tag on the cartridge. In particular, the application 32 may decrypt the encrypted tag to retrieve information related to a previous usage of the cartridge by the dispenser 6 or other dispensers.

From operation 515, the routine 500 continues to operation 520, where the application 32 executing on the dispenser 6, may retrieve a current usage status for the cartridge based on the decrypted tag. In particular, the application 32 may be configured to parse the bits data structure 21 (discussed above with respect to FIG. 4) for cartridge usage data including, without limitation, a current volume of a product available to be dispensed from the cartridge and a product use-by date.

From operation 520, the routine 500 continues to operation 525, where the application 32 executing on the dispenser 6, may determine if the cartridge has been retired based on the current usage status retrieved at operation 520. For example, the application 32 may determine that a cartridge has been retired based on one or more of a combination of triggers including a low cartridge product volume (e.g., the cartridge is between zero and five percent full) and an expired use-by date.

If, at operation 525, the application 32 determines that the cartridge has not been retired, then the routine 500 continues to operation 530 where the application 32 may configure the dispenser for dispense of the product from the cartridge. From operation 530, the routine 500 then ends.

If, at operation 525, the application 32 determines that the cartridge has been retired, then the routine 500 branches to operation 535 where the application 32 executing on the dispenser 6, may generate an alert message in the dispenser user interface. For example, the alert message may include the display of an error message in the dispenser user interface indicating that the inserted cartridge may not be utilized to dispense a product.

From operation 535, the routine 500 continues to operation 540, where the application 32 executing on the dispenser 6, may display a cartridge reorder message in the dispenser user interface. For example, the reorder message may include instructions telling a user how to order an approved replacement for the retired cartridge.

From operation 540, the routine 500 may continue to optional operation 545, where the application 32 executing on the dispenser 6, may send a notification message identifying the retired cartridge to other dispensers which may be in communication with the dispenser 6. For example, the application 32 may be configured to send the Retired Cartridge Data message 42 (i.e., indicating that a cartridge has been retired and thus should not be reused) to the dispensers 8 and 10. The Retired Cartridge Data message 42 may include a unique ID for identifying the cartridge in order to prevent the reuse of the cartridge in other dispensers. The message 42 may also include the use-by date associated with the unique ID. From optional operation 545, the routine 500 then ends.

FIG. 6 is a flow diagram illustrating a routine 600 for tracking the use of cartridges between dispensers to prevent their reuse, in accordance with an embodiment. The routine 600 begins at operation 605, where a server application (e.g., the application 75 executing on the server 70 of FIG. 2) may maintain a database of usage data from cartridges for various dispenser cartridges housed in a group of dispensers in a network. In some embodiments, the usage data maintained for each cartridge may include a cartridge identification number and one or more of product use-by date data, product volume data and product sold-out status data. In some embodiments, the application 75 may be configured to receive the cartridge usage data 47A-47N from the dispensers 45A-45N and save it to the database 80. It should be understood that if the database 80 contains previously stored usage data for a cartridge, the newly received cartridge usage data 47A-47N may be used to update the previously stored usage data.

From operation 605, the routine 600 continues to operation 610, where the application 75 executing on the server 70 may determine that one or more cartridges have been retired based on the usage data received at operation 605. For example, the cartridge usage data 47A may indicate that a cartridge in the dispenser 45A has less than a five percent product volume remaining and thus should not be reused.

From operation 610, the routine 600 continues to operation 615, where the application 75 executing on the server 70 may generate a report of retired cartridges based on the determination made at operation 610. In some embodiments, the report may include a listing of unique IDs for cartridges determined to be retired. The report may also include a use-by paired with each of the unique IDs.

From operation 615, the routine 600 continues to operation 620, where the application 75 executing on the server 70 may send the report generated at operation 620 to dispensers which are in communication with the server 70. In some embodiments, the application 75 may be configured to send the report in response to a query to the server 70 from any of the dispensers 45A-45N upon a cartridge being inserted in any of the dispensers 45A-45N. In other embodiments, the server 70 may be configured to automatically send the report as a broadcast message to the dispensers 45A-45N according to a predetermined schedule (e.g., every morning at 2 A.M.). The dispensers 45A-45N may then check currently installed cartridges and any retired cartridges. The dispensers 45A-45N may then prevent dispensing product from any retired cartridges included in the report. From operation 620, the routine 600 then ends.

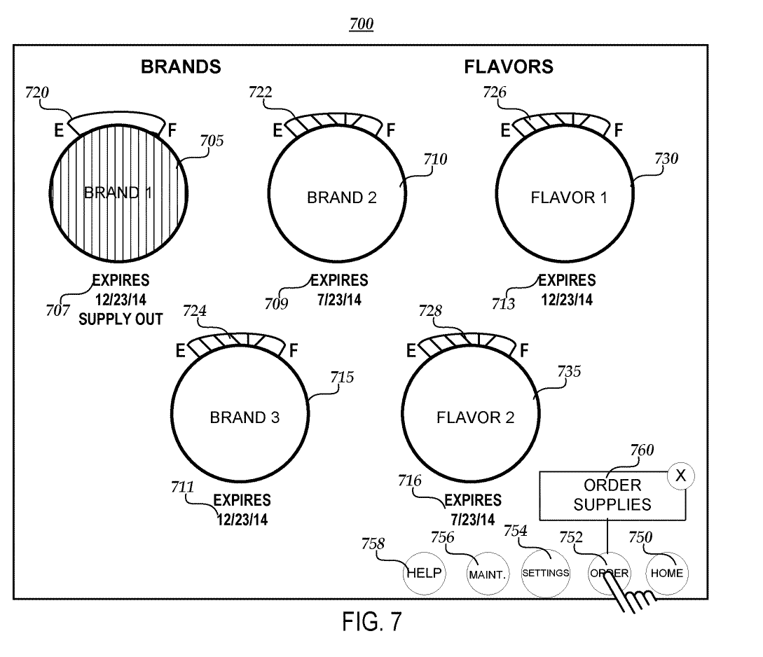

FIG. 7 shows a user interface 700 which may be utilized for tracking cartridge volume and reordering additional cartridges from the dispenser 6, in accordance with an embodiment. The user interface 700 may display icons 705, 710, 715, 730 and 735 representing product brands and flavors which may be dispensed from the cartridges 16, 20, 24 and 28 in the dispenser 6. The product brand and flavor icons 705, 710, 715, 730 and 735 may also be appended with use-by date information 707, 709, 711, 713 and 716 which indicates when a product brand or flavor, which may be dispensed by the dispenser 6, will expire. The product brand and flavor icons 705, 710, 715, 730 and 735 may also be associated with volume indicators 720, 722, 724, 726 and 728, respectively. In some embodiments, the volume indicators may function as “fuel gauges” and provide a visual indication to the user as to the amount of product remaining in a cartridge which may be dispensed. For example, the volume indicator 720 associated with the product brand icon 705 has a status of empty which is further visually indicated by the product brand icon 705 being highlighted as well as the words “supply out” being added to the appended use-by date information 707. The user interface 700 further includes a “Home” user control 750, an “Order” user control 752, a “Settings” user control 754, a “Maintenance” user control 756 and a “Help” user control 758. The user controls 750-758 may be selected by a user to access various additional functions and/or menus associated with the dispenser 6 including reordering supplies (e.g., cartridges) which may be shown as an additional user control control 760 generated in response to a user selecting the Order user control 752.

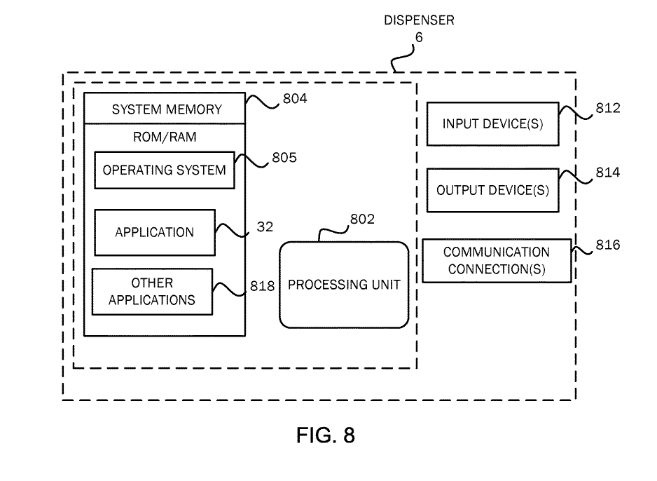

FIG. 8 is a simplified block diagram of the dispenser 6 with which various embodiments may be practiced. In a basic configuration, the dispenser 6 may comprise a computing device which includes at least one processing unit 802 and a system memory 804. Depending on the configuration and type of computing device, system memory 804 may comprise, but is not limited to, volatile (e.g. random access memory (RAM)), non-volatile (e.g. read-only memory (ROM)), flash memory, or any combination. System memory 804 may include an operating system 805, the application 32 and other applications 818. The operating system 805 may be suitable for controlling the dispenser 6's operation.

The dispenser 6 may have additional features or functionality. For example, the dispenser 6 may also include additional data storage devices (not shown) which may be removable and/or non-removable such as, for example, magnetic disks, optical disks, solid state storage devices (“SSD”), flash memory or tape. The dispenser 6 may also have input device(s) 812 such as a keyboard, a mouse, a pen, a sound input device (e.g., a microphone), a touch input device, etc. Output device(s) 814 such as a display, speakers, a printer, etc. may also be included. The aforementioned devices are examples and others may be used. Communication connection(s) 816 may also be included and utilized to connect to the Internet (or other types of networks) as well as to remote computing systems. It should be understood that the computing device components described above may also be suitable for the dispensers 8, 10 and 45A-45N as well as the server 70 described above with respect to FIGS. 1 and 2.

Various embodiments, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information (such as computer readable instructions, data structures, program modules, or other data) in hardware. The system memory 804 is an example of computer storage media (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by the dispenser 6. Any such computer storage media may also be part of the dispenser 6. Computer storage media does not include a carrier wave or other propagated or modulated data signal.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Various embodiments are described above with reference to block diagrams and/or operational illustrations of methods, systems, and computer program products. The operations/acts noted in the blocks may be skipped or occur out of the order as shown in any flow diagram. For example, two or more blocks shown in succession may in fact be executed substantially concurrently or the blocks may sometimes be executed in the reverse order, depending upon the functionality/acts involved.

Although the invention has been described in connection with various illustrative embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

1. A method comprising:
receiving, by a computing device, a cartridge for dispensing a product;
reading, by the computing device, an encrypted tag from the cartridge;
decrypting, by the computing device, the encrypted tag;
retrieving, by the computing device, a current usage status for the cartridge based on the decrypted tag;
determining, by the computing device, from the current usage status whether the cartridge has been retired; and
generating, by the computing device, an alert message upon determining that the cartridge has been retired.

2. The method of claim 1, wherein generating, by the computing device, an alert message upon determining that the cartridge has been retired comprises displaying an error message in a user interface on the computing device.

3. The method of claim 2, further comprising displaying instructions for ordering a replacement for the retired cartridge in the user interface.

4. The method of claim 1, further comprising sending a message to at least one other computing device compatible with the cartridge, the message comprising a notification that the cartridge has been retired.

5. The method of claim 1, further comprising configuring the computing device to dispense the product from the cartridge upon determining an absence of a retired state for the cartridge.

6. The method of claim 1, wherein reading, by the computing device, an encrypted tag from the cartridge comprises reading one or more of a radio frequency identification (RFID) label and a barcode upon an insertion of the cartridge in the computing device.

7. The method of claim 1, wherein retrieving, by the computing device, a current usage status for the cartridge based on the decrypted tag comprises retrieving information stored in the decrypted tag associated with the current usage status for the cartridge.

8. The method of claim 7, wherein retrieving information stored in the decrypted tag associated with the current usage status for the cartridge comprises retrieving product use-by date data from a plurality of bits comprising the decrypted cartridge tag.

9. The method of claim 7, wherein retrieving information stored in the decrypted tag associated with the current usage status for the cartridge comprises retrieving product volume data from a plurality of bits comprising the decrypted cartridge tag.

10. The method of claim 1, wherein the computing device comprises a consumable product dispenser.

11. The method of claim 10, wherein the consumable product dispenser comprises a beverage dispenser.

12. The method of claim 1, wherein the product comprises one of a consumable product and a consumable product ingredient.

13. The method of claim 12, wherein the one of the consumable product and the consumable product ingredient comprises one of a beverage product and a beverage ingredient.

14. A server computing device, comprising:
a memory for storing executable program code; and
a processor, functionally coupled to the memory, the processor being responsive to computer-executable instructions contained in the program code and operative to:
maintain a database of usage data from a plurality of cartridges for dispensing a product from one or more dispensers in communication with the server computing device;
determine from the usage data whether at least one of the plurality of cartridges has been retired in the one or more dispensers;
generate a report of retired cartridges upon determining that the at least one of the plurality of cartridges has been retired; and
send the report of retired cartridges to the one or more dispensers.

15. The server computing device of claim 14, wherein the processor, in maintaining usage data from a plurality of cartridges for dispensing a product from one or more dispensers in communication with the server computing device, is operative to:
receive the usage data from one or more of the plurality of cartridges; and
update previously stored usage data for the one or more of the plurality of cartridges with the received usage data in the database.

16. The server computing device of claim 14, wherein the processor, in sending the report of retired cartridges to the one or more dispensers, is operative to periodically communicate the report of retired cartridges to the one or more dispensers according to a predetermined schedule.

17. The server computing device of claim 14, wherein the processor, in sending the report of retired cartridges to the one or more dispensers, is operative to:
receive a query from the one or more dispensers; and
send the report of retired cartridges to the one or more dispensers in response to the query.

18. The server computing device of claim 14, wherein the usage data for each of the plurality of cartridges comprises a cartridge identification number and one or more of product use-by date data, product volume data and product sold-out status data.

19. The server computing device of claim 14, wherein the one or more dispensers comprises one or more consumable product dispensers.

20. The server computing device of claim 19, wherein the one or more consumable product dispensers comprises one or more beverage dispensers.

21. The server computing device of claim 14, wherein the product comprises one of a consumable product and a consumable product ingredient.

22. The server computing device of claim 21, wherein the one of the consumable product and the consumable product ingredient comprises one of a beverage product and a beverage ingredient.

23.-32. (canceled)
